(19) United States
(12) Patent Application Publication
(10) Pub. No.: US 2013/0176864 A1
(43) Pub. Date: Jul. 11, 2013

(54) RATE AND POWER CONTROL SYSTEMS AND METHODS

(71) Applicant: Qualcomm Incorporated, San Diego, CA (US)

(72) Inventors: Zhi Quan, San Diego, CA (US); Simone Merlin, San Diego, CA (US); Vincent K. Jones, Redwood City, CA (US); Albert Van Zelst, Woerden (NL)

(73) Assignee: Qualcomm Incorporated, San Diego, CA (US)

(21) Appl. No.: 13/668,119

(22) Filed: Nov. 2, 2012

Related U.S. Application Data
(60) Provisional application No. 61/584,690, filed on Jan. 9, 2012.
(60) Provisional application No. 61/606,862, filed on Mar. 5, 2012.
(60) Provisional application No. 61/611,677, filed on Mar. 16, 2012.

(51) Int. Cl. H04W 72/04

(52) U.S. Cl. CPC H04W 72/0473
USPC 370/245; 370/329; 370/311; 370/252

(57) ABSTRACT

A method includes transmitting a packet from a first wireless device to a second wireless device, where data within the packet is encoded and a signal representing the packet is modulated in accordance with a modulation and coding scheme (MCS). The method also includes, responsive to receiving an acknowledgement packet that includes a MCS change indicator from the second wireless device via a wireless local area network (WLAN) in response to transmitting the packet, maintaining the MCS when the MCS change indicator has a first value and incrementing the MCS when the MCS has a second value.

### CROSS REFERENCE TO RELATED APPLICATIONS

The present application claims priority from commonly owned U.S. Provisional Patent Application No. 61/584,690 filed Jan. 9, 2012, U.S. Provisional Patent Application No. 61/606,862 filed Mar. 5, 2012, and U.S. Provisional Patent Application No. 61/611,677 filed Mar. 16, 2012, the contents of which are expressly incorporated herein by reference in their entirety.

### FIELD OF THE DISCLOSURE

The present disclosure is generally related to adaptive rate and power control for wireless devices.

### BACKGROUND

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet Protocol (IP) telephones, can communicate voice and data packets over wireless networks. Many such wireless telephones incorporate additional devices to provide enhanced functionality for end users. For example, a wireless telephone can also include a digital still camera, a digital video camera, a digital recorder, and an audio file player. Also, such wireless telephones can execute software applications, such as a web browser application that can be used to access the Internet. As such, these wireless telephones can include significant computing capabilities.

As demand for wireless data communications has increased, the number of wireless devices operating in particular areas has increased. Consequently, wireless airwaves may be congested, and wireless channel conditions may fluctuate. To counter fluctuating channel conditions, a wireless device may perform link adaptation and/or power control to modify a transmission rate and/or a transmission power level. For successful data communication over a channel having a fixed set of channel conditions, transmission rate and transmission power level may behave inversely. To illustrate, when channel conditions deteriorate, a wireless device may decrease transmission rate or increase transmission power level to maintain successful communication. Typically, a wireless device may perform link adaptation by transmitting a large number of packets to a destination and estimating a percentage of packet loss during the transmission. Based on the percentage of packet loss, the wireless device may increase or decrease its transmission rate.

The Institute of Electrical and Electronics Engineers (IEEE) 802.11n standard defines fast link adaptation based on modulation and coding scheme (MCS), a property that impacts transmission rate. To perform fast link adaptation, a wireless device may transmit a packet with a MCS request bit asserted. In response to receiving the packet with the asserted MCS request bit, a destination device may transmit a reply packet that includes a seven-bit MCS feedback (MFB) field. Upon receiving the reply packet, the wireless device may change its MCS to the MCS specified by the MFB field, thereby modifying its transmission rate. In other implementations, a wireless device may transmit a high throughput (HT) control field encoded at higher MCS than an MCS used for a physical layer (PHY) preamble. The receiver may be unable to decode the HT control field, resulting in a decoding error. If the receiver fails to decode the HT control field, it does not know what to do with the MCS feedback. The transmitter thus has to use a lowest MCS, resulting in inefficiency. IEEE 802.11n also defines a dedicated request-response messaging protocol to perform power control. Wireless devices operating in accordance with the IEEE 802.11n standard may perform link adaptation and power control in response to changes in channel conditions, which may be frequent. Systems relying on existing link adaptation and power control schemes may incur significant overhead in managing changing channel conditions.

### SUMMARY

Systems and methods of performing link adaptation and power control with decreased overhead are disclosed. In particular, the described techniques may find application in IEEE 802.11ah devices that may have low duty cycles. To illustrate, a wireless sensor that communicates over an IEEE 802.11ah network may wake up for a few seconds to perform a few measurements, communicate results of the measurements to a destination, and then sleep for a few minutes. Because the sensor has a low duty cycle (i.e., a short “active state” duration), the sensor may not be able to perform traditional link adaptation by transmitting a large number of packets and estimating packet loss. Use of fast link adaptation and power control as defined in IEEE 802.11n may cause an unacceptable amount of overhead. Moreover, when and how often link adaptation or power control is performed may be unpredictable. Instead, in accordance with the described techniques, the wireless sensor may perform “differential” link adaptation and power control, which may involve exchanging as few as one or two bits with another device. The disclosed techniques may be considered “differential” because a receiver may instruct a transmitter whether to change MCS or power level, but not provide a specific value for the transmitter to change to. The disclosed techniques may enable a transmitter to control when and how often link adaptation or power control is performed and may enable the transmitter to perform link adaptation and power control simultaneously.

To perform link adaptation (also referred to as “rate control” herein), a transmitter may send a packet to a receiver using a particular MCS. The receiver may estimate a second MCS based on a signal characteristic (e.g., signal to noise ratio (SNR), signal to interference plus noise ratio (SINR), and/or received signal strength indication (RSSI)) that is derived from the received packet. When the second MCS is greater than the first MCS, the receiver may send an acknowledgement (ACK) packet to the transmitter, where the ACK packet includes bit(s) (e.g., a MCS change indicator) instructing the transmitter to increase its MCS. Alternately, when the second MCS is less than or equal to the first MCS, the ACK packet includes bit(s) that instruct the transmitter to maintain the current MCS (i.e., the first MCS). In one embodiment, the MCS change indicator may include fewer than seven bits. In another embodiment, the MCS change indicator is a single bit. In some embodiments, the ACK packet may be used to instruct the transmitter to decrease its MCS.

To perform power control, the transmitter may send a packet to a receiver at a particular power level using a selected MCS. The receiver may estimate a signal characteristic (e.g., SINR) based on the received packet and may compare the signal characteristic to a “target” signal characteristic associated with the selected MCS. Based on the comparison, the receiver may instruct the transmitter whether to decrease its transmission power level (e.g., using one or more bits in an ACK packet). In some embodiments, the ACK packet may be used to instruct the transmitter to increase its transmission power level.

In some implementations, when the receiver cannot successfully decode a transmitted packet, the receiver may send a negative acknowledgement (NACK) packet, where the NACK packet includes a bit indicating whether the decoding error was due to poor channel conditions (in which case the transmitter should change MCS and/or transmit power level) or a collision (in which case the transmitter should retry transmission while maintaining the MCS and the transmit power level). To illustrate, the receiver may determine an error in response to decoding a physical layer (PHY) preamble of a packet but not the remainder of the packet, and the receiver may determine whether the decoding error was due to poor channel conditions or due to a collision. The receiver may indicate the cause of the decoding error in the NACK packet, and the transmitter may selectively increase, decrease, or maintain its MCS and/or transmission power level in response to the indicated cause of the decoding error.

In a particular embodiment, a method includes transmitting a packet from a first wireless device to a second wireless device, where data within the packet is encoded and a signal representing the packet is modulated in accordance with a modulation and coding scheme (MCS). The method also includes, responsive to receiving an acknowledgement packet including a MCS change indicator from the second wireless device via a wireless local area network (WLAN) in response to transmitting the packet, maintaining the MCS when the MCS change indicator has a first value and incrementing the MCS when the MCS change indicator has a second value.

In another particular embodiment, a method includes receiving a packet transmitted by a first wireless device at a second wireless device, the packet indicating a first modulation and coding scheme (MCS). The method also includes estimating a second MCS at the second wireless device based on a signal characteristic derived from the packet. The method further includes transmitting a first acknowledgement packet from the second wireless device to the first wireless device with a MCS change indicator when the second MCS is greater than the first MCS. The MCS change indicator instructs the first wireless device to increment the first MCS when the first MCS is less than a particular level and to reduce a transmit power when the first MCS is at the particular level. The method further includes transmitting a second acknowledgement packet to the first wireless device with an indicator that instructs the first wireless device to maintain the first MCS when the second MCS is less than or equal to the first MCS.

In another particular embodiment, a method includes transmitting a packet from a first wireless device to a second wireless device at a transmit power level. When an acknowledgement packet that includes a transmit power level change indicator is received from the second wireless device in response to transmitting the packet, the method includes maintaining the transmit power level when the transmit power level change indicator has a first value. The method further includes decreasing the transmit power level when the transmit power level change indicator has a second value.

In another particular embodiment, a method includes receiving a packet transmitted by a first wireless device at a second wireless device, the packet indicating a selected modulation and coding scheme (MCS) and transmitted at a transmit power level. The method also includes comparing a signal characteristic derived from the packet to a target signal characteristic associated with the selected MCS. When the derived signal characteristic is greater than the target signal characteristic, the method further includes sending a first acknowledgement packet from the second wireless device to the first wireless device, where the first acknowledgement packet includes a transmit power level change indicator instructing the first wireless device to decrease the transmit power level. When the derived signal characteristic is less than or equal to the target signal characteristic, the method includes sending a second acknowledgement packet to the first wireless device with an indicator instructing the first wireless device to maintain the transmit power level.

In another particular embodiment, a method includes receiving a packet transmitted by a first wireless device at a second wireless device, the packet indicating a modulation and coding scheme (MCS) and transmitted at a transmit power level. In response to an error detected during decoding of the packet, the method also includes determining whether the error is caused by a channel condition or a collision. The method includes transmitting a negative acknowledgement packet to the first wireless device based on the determination. When the error is caused by the channel condition, the negative acknowledgement packet instructs the first wireless device to decrease the MCS, increase the transmit power level, or any combination thereof. When the error is caused by the collision, the negative acknowledgement packet instructs the first wireless device to maintain the MCS and the transmit power level.

In another particular embodiment, an apparatus includes a processor and a memory storing instructions executable by the processor to initiate transmission of a packet to a wireless device, where data within the packet is encoded and a signal representing the packet is modulated in accordance with a modulation and coding scheme (MCS) and where the signal is transmitted at a transmit power level. The instructions are further executable by the processor to, responsive to receipt of an acknowledgement packet from the wireless device via a wireless local area network (WLAN) in response to transmitting the packet, maintain the MCS when a MCS change indicator of the acknowledgement packet has a first value, increment the MCS when the MCS change indicator of the acknowledgement packet has a second value. In another particular embodiment, an apparatus includes a processor and a memory storing instructions executable by the processor to detect receipt of a packet transmitted from a wireless device, the packet indicating a first modulation and coding scheme (MCS) and transmitted at a transmit power level. The instructions are further executable by the processor to estimate a second MCS based on a signal characteristic derived from the packet. The instructions are further executable by the processor to initiate transmission of an acknowledgement packet that includes a MCS change indicator to the wireless device. The MCS change indicator instructs the wireless device to increment the first MCS when the second MCS is greater than the first MCS and the first MCS is less than a particular level. The MCS change indicator instructs the wireless device to reduce a transmit power level when the second MCS is greater than the first MCS and the first MCS is at the particular level. The MCS change indicator instructs the wireless device to maintain the first MCS when the second MCS is less than or equal to the first MCS.

In another particular embodiment, an apparatus includes a processor and a memory storing instructions executable by the processor to initiate transmission of a packet from a first wireless device to a second wireless device at a transmit power level. When an acknowledgement packet that includes a transmit power level change indicator is received from the second wireless device in response to transmitting the packet, the instructions are further executable by the processor to maintain the transmit power level when the transmit power level change indicator has a first value. The instructions are further executable by the processor to decrease the transmit power level when the transmit power level change indicator has a second value.

In another particular embodiment, an apparatus includes a processor and a memory storing instructions executable by the processor to detect receipt of a packet transmitted from a wireless device, the packet indicating a selected modulation and coding scheme (MCS) and transmitted at a transmit power level. The instructions are further executable by the processor to compare a signal characteristic derived from the packet to a target signal characteristic. The instructions are further executable by the processor to initiate transmission of an acknowledgement packet to the wireless device. When the derived signal characteristic is greater than the target signal characteristic, the acknowledgement packet includes a transmit power level change indicator that instructs the wireless device to decrease the transmit power level. When the derived signal characteristic is less than or equal to the target signal characteristic, the acknowledgement packet includes an indicator that instructs the wireless device to maintain the transmit power level.

In another particular embodiment, an apparatus includes a processor and a memory storing instructions executable by the processor to detect receipt of a packet transmitted from a wireless device, the packet indicating a modulation and coding scheme (MCS) and transmitted at a transmit power level. The instructions are further executable by the processor to, in response to an error detected during decoding of the packet, determine whether the error is caused by a channel condition or a collision. The instructions are further executable by the processor to initiate transmission of a negative acknowledgement packet to the wireless device based on the determination. When the error is caused by the channel condition, the negative acknowledgement packet instructs the wireless device to decrease the MCS, increase the transmit power level, or any combination thereof. When the error is caused by the collision, the negative acknowledgement packet instructs the wireless device to maintain the MCS and the transmit power level.

One advantage provided by at least one of the described embodiments includes an ability to perform rate control and power control with decreased overhead. Another particular advantage provided by at least one of the described embodiments includes an ability to perform rate control and power control by use of existing data transmission/acknowledgement protocols without introducing dedicated rate control or power control messaging.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

FIG. 1 is a diagram of a particular embodiment of a system that is operable to perform rate and power control;

FIG. 2 is a diagram of particular embodiments of the acknowledgement (ACK) packet sent by the second wireless device in the system of FIG. 1;

FIG. 3 is a flowchart of a particular embodiment of a method of performing rate control;

FIG. 4 is a flowchart of a particular embodiment of a method of performing power control;

FIG. 5 is a flow chart of a particular embodiment of a method of performing collision detection in conjunction with the method of FIG. 3 or the method of FIG. 4; and

FIG. 6 is a block diagram of a particular embodiment of a wireless device operable to perform rate control and power control.

### DETAILED DESCRIPTION

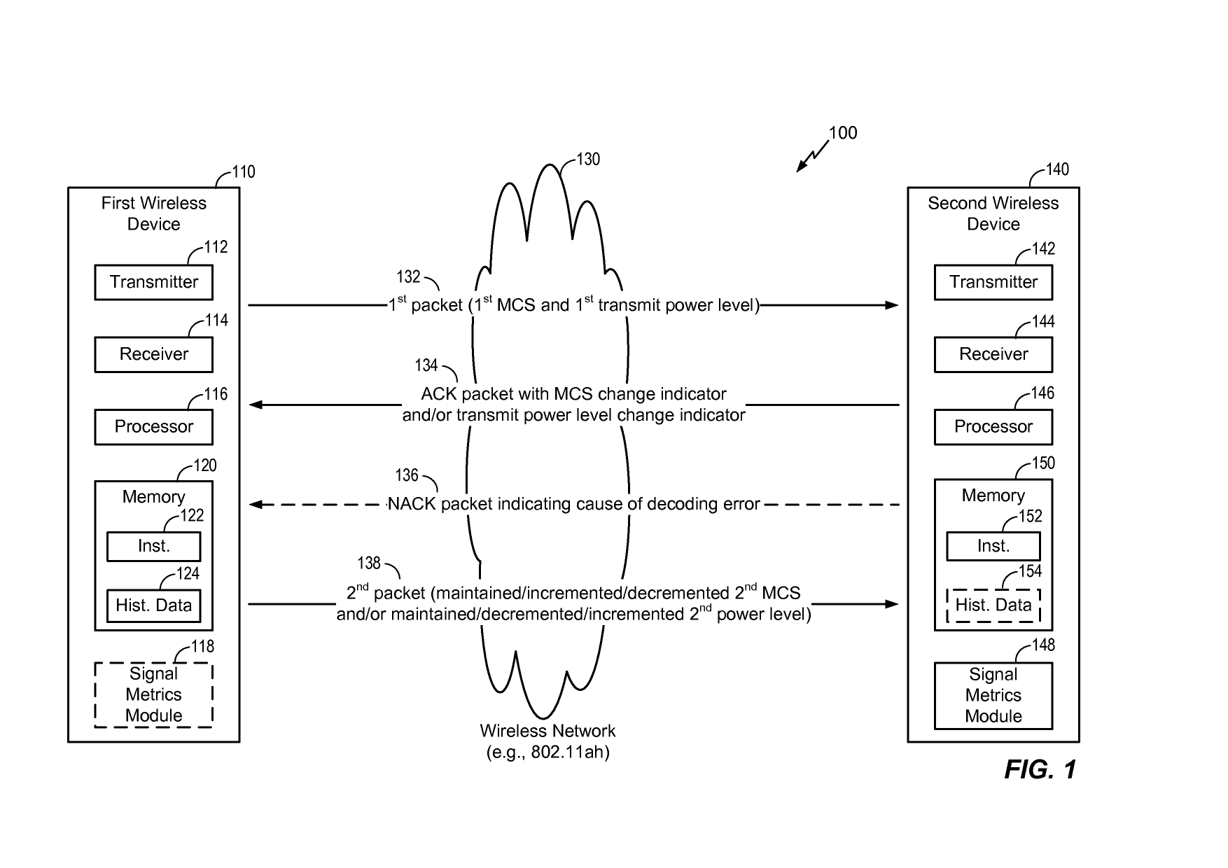

Referring to FIG. 1, a diagram of a particular embodiment of a system that is operable to perform rate and power control is disclosed and generally designated 100. The system 100 includes a first wireless device 110 connected to a second wireless device 140 via a wireless network 130 (e.g., an Institute of Electrical and Electronics Engineers (IEEE) 802.11ah wireless network, a wireless local area network (WLAN) compliant with an IEEE 802.11 protocol, etc.). The first wireless device 110 and the second wireless device 140 may exchange data (e.g., data packet, acknowledgment (ACK) packet, and negative acknowledgement (NACK) packet) via the wireless network 130.

The first wireless device 110 includes a transmitter 112, a receiver 114, a processor 116, a signal metrics module 118, and a memory 120. The memory 120 may store instructions 122 executable by the processor 116, and the memory 120 may store historical data 124 (e.g., historical transmit power levels and modulation and coding schemes (MCS)). The signal metrics module 118 may determine signal characteristics of a received signal. Signal characteristics may include signal to noise ratio (SNR), signal to interference plus noise ratio (SINR), and a received signal strength indication (RSSI) that may be derived from received signals and/or packets. It should be noted that the signal metrics module 118 may be implemented as hardware and/or as executable instructions (e.g., instructions 122) stored in the memory 120. Although the transmitter 112 and the receiver 114 are shown as two separate components, the transmitter 112 and the receiver 114 may be integrated into one component (e.g., a transceiver) configured to transmit and receive signals/packets via the wireless network 130. Similarly, the second wireless device 140 may include a transmitter 142, a receiver 144, a processor 146, a signal metrics module 148, and a memory 150 that stores instructions 152 executable by the processor 146 and that stores historical data 154.

During operation, the first wireless device 110 (e.g., an IEEE 802.11ah sensor or other devices having a low duty cycle) may transmit a first packet 132 to the second wireless device 140 (e.g., another IEEE 802.11ah device or a non-IEEE 802.11ah device) using a first modulation and coding scheme (MCS) and at a first transmit power level. Specifically, data within the first packet 132 may be encoded and a signal representing the first packet 132 may be modulated in accordance with the first MCS; the signal may be transmitted at the first transmit power level. In a particular embodiment, the first MCS may be a “lowest MCS” that is selected upon a wakeup of the first wireless device 110 (e.g., when the first wireless device 110 is turned ‘on’ or when the first wireless device exits a “power save” mode). For example, the “lowest MCS” may be a lowest possible MCS of the first wireless device 110, a lowest historically used MCS with respect to communicating data packets with the second wireless device 140 (e.g., as determined from the historical data 124), a lowest historically used MCS with respect to a particular wireless channel in use by the first wireless device 110 (e.g., as determined from the historical data 124), or any combination thereof. For example, the lowest possible MCS may be based on a lowest data rate at which the first wireless device 110 may transmit data using a particular modulation technique (e.g., binary phase shift keying (BPSK)).

The second wireless device 140 may receive the first packet 132 and may estimate a second MCS based on a signal characteristic derived from the first packet 132, and the second wireless device 140 may compare the signal characteristic derived from the first packet 132 to a target (e.g., “optimum” or “expected”) signal characteristic associated with the first MCS, or a combination thereof. For example, the estimation of the second MCS and the comparison of the signal characteristic may be performed by executing instructions 152 at the processor 146 of the second wireless device 140. The signal characteristic may include a SNR, a SINR, a RSSI, or any combination thereof. In a particular embodiment, the second wireless device 140 may determine whether to instruct the first wireless device 110 to change the first MCS based on the estimated second MCS and/or whether to instruct the first wireless device 110 to change the first transmit power level based on the target signal characteristic.

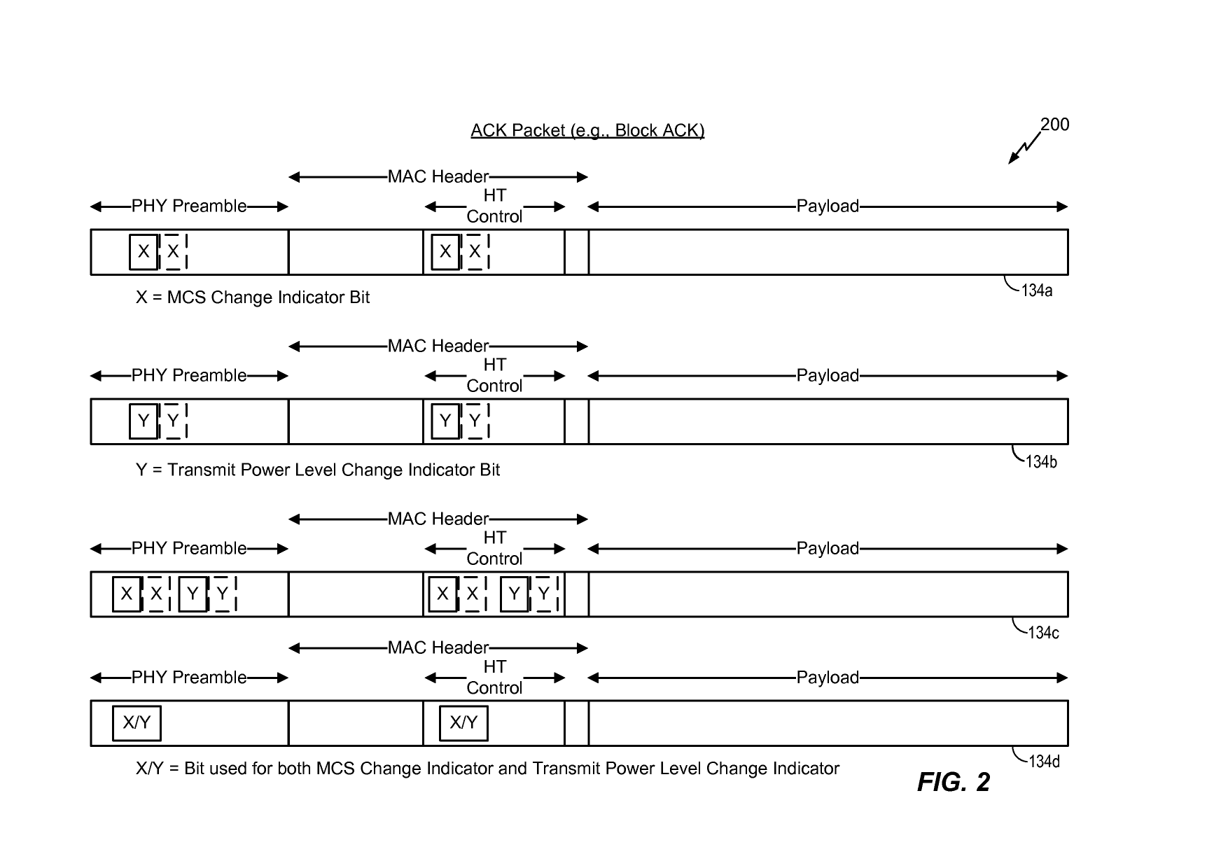

A command or instruction(s) that indicates whether to change the first MCS and/or the first transmit power level may be represented by a portion of an acknowledgement (ACK) packet 134 sent from the second wireless device 140 to the first wireless device 110. In a particular embodiment, the ACK packet 134 includes one or more bits (i.e., a MCS change indicator) that instruct the first wireless device 110 whether to change or to maintain the first MCS. In another particular embodiment, the ACK packet 134 includes one or more bits (i.e., a transmit power level change indicator) that instruct the first wireless device 110 whether to change or to maintain the first transmit power level. In various embodiments, the MCS change indicator and the transmit power level change indicator may be represented as single bits, a pair of bits (i.e., 2 bits), or some other number of bits in the ACK packet 134. In a particular embodiment, the MCS change indicator and the transmit power level change indicator may each include fewer than seven bits, resulting in less overhead than the IEEE 802.11n fast link adaptation implementation. An example of the ACK packet 134 including the MCS change indicator and/or the transmit power level change indicator is described in further detail with reference to FIG. 2. In particular embodiment, the first wireless device 110 changes the first transmit power level in response to the MCS change indicator.

In a particular embodiment, when the second MCS is greater than the first MCS, the MCS change indicator may instruct the first wireless device 110 to increase the first MCS. When the second MCS is less than or equal to the first MCS, the MCS change indicator may instruct the first wireless device 110 to maintain the first MCS. When the MCS change indicator is a single bit, ‘0’ may indicate “maintain MCS” and ‘1’ may indicate “increment MCS.” When the MCS change indicator is two bits, ‘00’ may indicate “maintain MCS,” ‘01’ may indicate “increment MCS by one,” ‘10’ may indicate “increment MCS by two,” and ‘11’ may indicate “increment MCS by three.” In some embodiments, a specific value of the MCS change indicator (i.e., a particular bit combination) may indicate “decrement the MCS.”

In a particular embodiment, when the derived signal characteristic (e.g., SNR, SINR, or RSSI) is greater than the target signal characteristic, the transmit power level change indicator may instruct the first wireless device 110 to decrease the first transmit power level. When the derived signal characteristic is less than or equal to the target signal characteristic, the transmit power level change indicator may instruct the first wireless device 110 to maintain the first transmit power level. When the transmit power level change indicator is a single bit, ‘0’ may indicate “maintain transmit power level” and ‘1’ may indicate “decrement transmit power level.” Alternately, the transmit power level change indicator may be two bits where a particular bit combination indicates “increment transmit power level.” Thus, the second wireless device 140 may send the ACK packet 134 with the MCS change indicator, the transmit power level change indicator, or a combination thereof, to the first wireless device 110 to provide instructions regarding whether the first MCS and the first transmit power level are to be modified.

In a particular embodiment, the second wireless device 140 may not successfully decode the first packet 132 sent by the first wireless device 110 and may send a negative acknowledgement (NACK) packet 136 to the first wireless device 110. For example, the second wireless device 140 may determine whether an error detected during decoding of the first packet 132 is caused by a channel condition or a collision and may send the NACK packet 136 to the first wireless device 110 based on the determination. When the error is caused by the channel condition, the NACK packet 136 may instruct the first wireless device 110 (or the first wireless device 110 may elect) to decrease the first MCS, increase the first transmit power level, or any combination thereof. When the error is caused by the collision, the NACK packet 136 may instruct the first wireless device 110 (or the first wireless device 110 may elect) to maintain the first MCS and the first transmit power level. Alternatively, the first wireless device 110 may update the MCS and/or the transmit power level even when the error was caused by a collision. In a particular embodiment, the second wireless device 140 may detect the error by successfully decoding a physical layer (PHY) preamble of the first packet 132 transmitted by the first wireless device 110 but unsuccessfully decoding a remainder of the first packet 132.

In a particular embodiment, the NACK packet 136 may include a bit indicating whether the decoding error was due to poor channel conditions (in which case the first wireless device 110 may change the first MCS and/or the first transmit power level) or a collision (in which case the first wireless device 110 may retry transmission while maintaining the first MCS and the first transmit power level). For example ‘0’ may indicate poor channel conditions and ‘1’ may indicate a collision, or vice versa.

The second wireless device 140 may detect a collision as a cause of a detected error in a number of ways. For example, the second wireless device 140 may infer collision by determining whether the RSSI derived from the first packet 132 is within a particular range. The second wireless device 140 may also infer collision by determining whether the RSSI is greater than a previous RSSI by more than a threshold amount and whether the SNR derived from the first packet 132 is less than a previous SNR, where the previous RSSI and the previous SNR are each derived from a previous packet received from the first wireless device 110. The second wireless device 140 may infer collision by determining whether the RSSI exhibits a sudden increase or decrease. In addition, the second wireless device 140 may infer collision by determining whether the SNR can support the first MCS. It should be noted that the second wireless device 140 may infer collision based on any combination of the above methods.

In response to receiving the MCS change indicator and/or the transmit power level change indicator in the ACK packet 134 from the second wireless device 140, the first wireless device 110 may maintain/increase/decrease the first MCS (e.g., increase to a second MCS or decrease to a third MCS) as instructed by the MCS change indicator and/or maintain/decrease/increase the transmit power level (e.g., increase to a second power level or decrease to a third power level) as instructed by the transmit power level change indicator. For example, the first wireless device 110 may subsequently transmit a second packet 138 to the second wireless device 140 using a second MCS (i.e., maintained/incremented/decremented MCS) and/or at a second transmit power level (i.e., maintained/decremented/incremented transmit power level). Thus, in accordance with the described techniques, the first wireless device may perform “differential” link adaptation and power control, which may involve exchanging as few as one or two bits with the second device, thereby reducing overhead. In a particular embodiment, the one or two bits may be included in a portion of the ACK packet 134. Moreover, the disclosed embodiments may enable a transmitter (e.g., the first wireless device 110 or the second wireless device 140) to control when and how often link adaptation or power control is performed, as well as enable the transmitter to perform link adaptation and power control simultaneously (e.g., using the MCS change indicator and the transmit power level change indicator in the ACK packet 134).

According to the described embodiments, fast rate/power control can be indicated (e.g., by one or more bits) in the PHY preamble or in the MAC header of a packet (e.g., the first packet 132) sent from a transmitter (e.g., the first wireless device 110) to a receiver (e.g., the second wireless device 140). In response, the receiver (e.g., the second wireless device 140) may return an ACK packet (e.g., the ACK packet 134) to the transmitter with appropriate fast rate/power control information (e.g., maintain MCS, increase MCS, or decrease MCS, and/or maintain transmit power level, increase transmit power level, or decrease transmit power level).

Referring to FIG. 2, a diagram of particular illustrative embodiments of the acknowledgement (ACK) packet 134 of FIG. 1 is disclosed and generally designated 200. In each embodiment, the ACK packet 134 (i.e., ACK packets 134a-134d) may include a physical layer (PHY) preamble, a media access control (MAC) header, and/or a payload. The MAC header may also include a high throughput (HT) control field. In a particular embodiment, the ACK packet 134 includes only the PHY preamble (e.g., is a “short” ACK).

In a first embodiment, the ACK packet 134a includes one or more MCS change indicator bits (designated ‘X’). For example, the MCS change indicator may be represented as a single bit (depicted in solid lines) or as a pair of bits (i.e., 2 bits) (depicted in broken lines). Further, the one or more MCS change indicator bits may be included in the PHY preamble of the ACK packet 134a (e.g., in a signal (SIG) field of the PHY preamble) or in the MAC header of the ACK packet 134a (e.g., in the HT control field of the MAC header). When the MCS change indicator X is a single bit, ‘0’ may indicate “maintain MCS” and ‘1’ may indicate “increment MCS.” When the MCS change indicator X is two bits, ‘00’ may indicate “maintain MCS,” ‘01’ may indicate “increment MCS by one,” ‘10’ may indicate “increment MCS by two,” and ‘11’ may indicate “increment MCS by three. In some embodiments, a specific value of the MCS change indicator X (i.e., a particular bit combination) may indicate “decrement MCS.”

In a second embodiment, the ACK packet 134b includes one or more transmit power level change indicator bits (designated ‘Y’). For example, the transmit power level change indicator may be represented as a single bit (depicted in broken lines) or as a pair of bits (i.e., 2 bits) (depicted in broken lines). Further, the one or more transmit power level change indicator bits may be included in the PHY preamble of the ACK packet 134b (e.g., in the signal (SIG) field of the PHY preamble) or in the MAC header of the ACK packet 134b (e.g., in the HT control field of the MAC header). When the transmit power level change indicator Y is a single bit, ‘0’ may indicate “maintain transmit power level” and ‘1’ may indicate “decrement transmit power level.” Alternately, the transmit power level change indicator Y may be two bits where a particular bit combination indicates “increment transmit power level.”

In a third embodiment, the ACK packet 134c includes one or more MCS change indicator bits X and one or more transmit power level change indicator bits Y (i.e., a combination of MCS change indicator bits X and transmit power level change indicator bits Y). In such an embodiment, the second wireless device 140 of FIG. 1 may send the ACK packet 134c with the MCS change indicator X, the transmit power level change indicator Y, or a combination thereof, to the first wireless device 110 to provide instructions regarding whether MCS and/or the transmit power level are to be modified.

In a fourth embodiment, the ACK packet 134d includes a single bit (designated X/Y) used for both the MCS change indicator and the transmit power level change indicator. For example, the MCS change indicator and the transmit power level change indicator may share at least one common bit. To illustrate, when the X/Y bit is a single bit, ‘0’ may indicate “change MCS” and ‘1’ may indicate “change transmit power level,” or vice versa. As another example, the MCS change indicator X and the transmit power level change indicator Y may share a pair of bits (i.e., 2 bits). When the MCS change indicator X and the transmit power level change indicator Y share 2 bits, for example, ‘00’ may indicate “maintain MCS,” ‘01’ may indicate “increment MCS,” ‘10’ may indicate “maintain transmit power level,” and ‘11’ may indicate “decrement transmit power level.” As a further example, the X/Y bits may be 3 bits where a particular combination of the X/Y bits (e.g., ‘000,’ ‘001,’ ‘010,’ and ‘011’) may be used to instruct the first wireless device 110 to maintain/increment/decrement the MCS and another particular combination of the X/Y bits (e.g., ‘100,’ ‘101,’ ‘110,’ and ‘111’) may be used to instruct the first wireless device 110 to maintain/increment/decrement the transmit power level. It should be noted that the ACK packet 134 may be a block ACK packet, where a single block ACK packet is sent to acknowledge several received frames which can significantly improve efficiency and throughput.

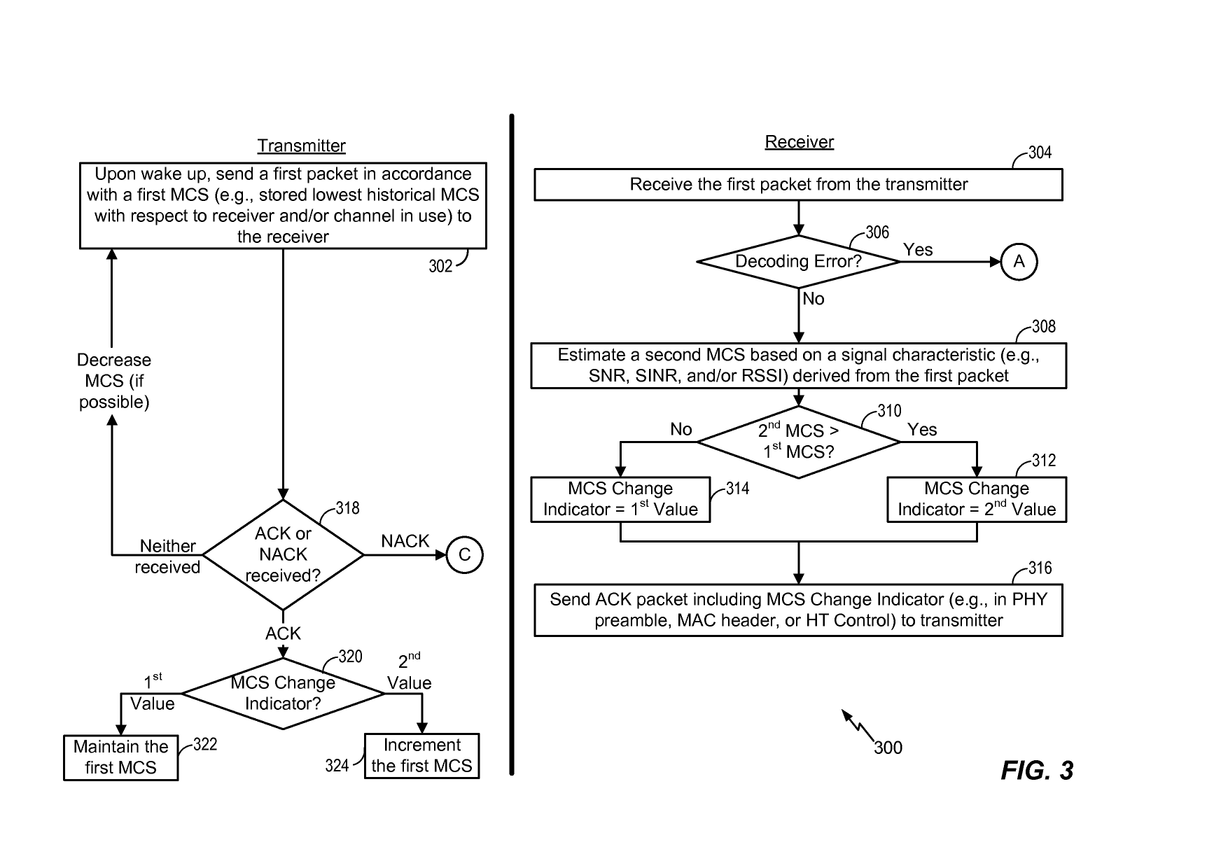

Referring to FIG. 3, a flowchart of a particular embodiment of a method of performing rate control is disclosed and generally designated 300. The method 300 may be performed by a transmitter (as shown on the left column) and a receiver (as shown on the right column). For example, the transmitter may be the first wireless device 110 of FIG. 1 and the receiver may be the second wireless device 140 of FIG. 1.

The method 300 includes, upon wake up, sending a first packet in accordance with a first MCS to a receiver, at 302. For example, the first wireless device 110 may transmit the first packet 132 to the second wireless device 140 using a first MCS and at a transmit power level “during power-on” (or upon exiting a power-save mode). In a particular embodiment, the first MCS may be a “lowest MCS” that is selected upon a wake up of the first wireless device 110. The “lowest MCS” may be a lowest possible MCS of the first wireless device 110, a lowest historically used MCS with respect to communicating data packets with the second wireless device 140 (e.g., as determined from the historical data 124), a lowest historically used MCS with respect to a particular wireless channel in use by the first wireless device 110 (e.g., as determined from the historical data 124), or any combination thereof.

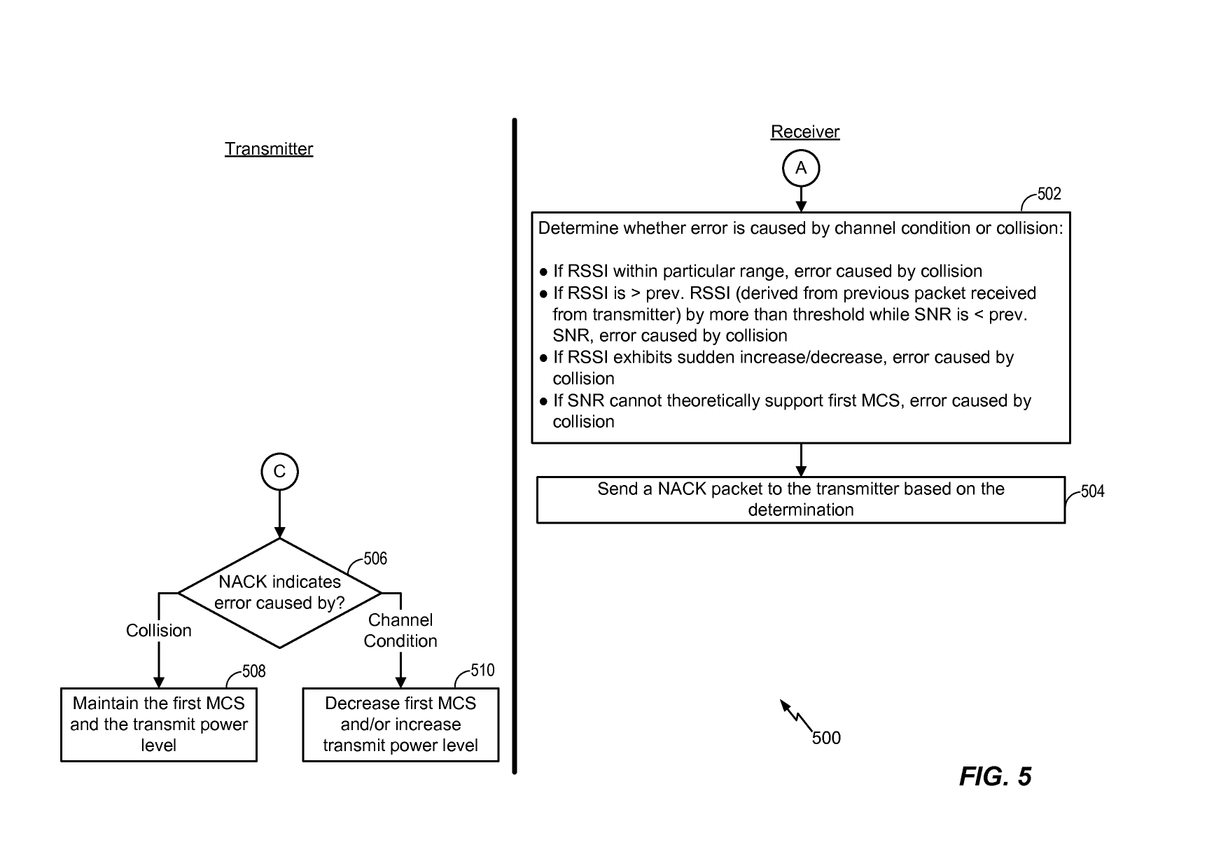

The method 300 includes receiving the first packet from the transmitter, at 304 and determining whether or not there is a decoding error, at 306. For example, the second wireless device 140 may receive the first packet 132 sent by the first wireless device 110 and may proceed to attempt to decode the first packet 132. If the second wireless device 140 successfully decodes the first packet 132, it is determined that there is no decoding error, at 306, and the method 300 proceeds to 308. However, if the second wireless device 140 cannot successfully decode the first packet 132, it is determined that there is a decoding error, at 306, and the method 300 proceeds to A (i.e., FIG. 5).

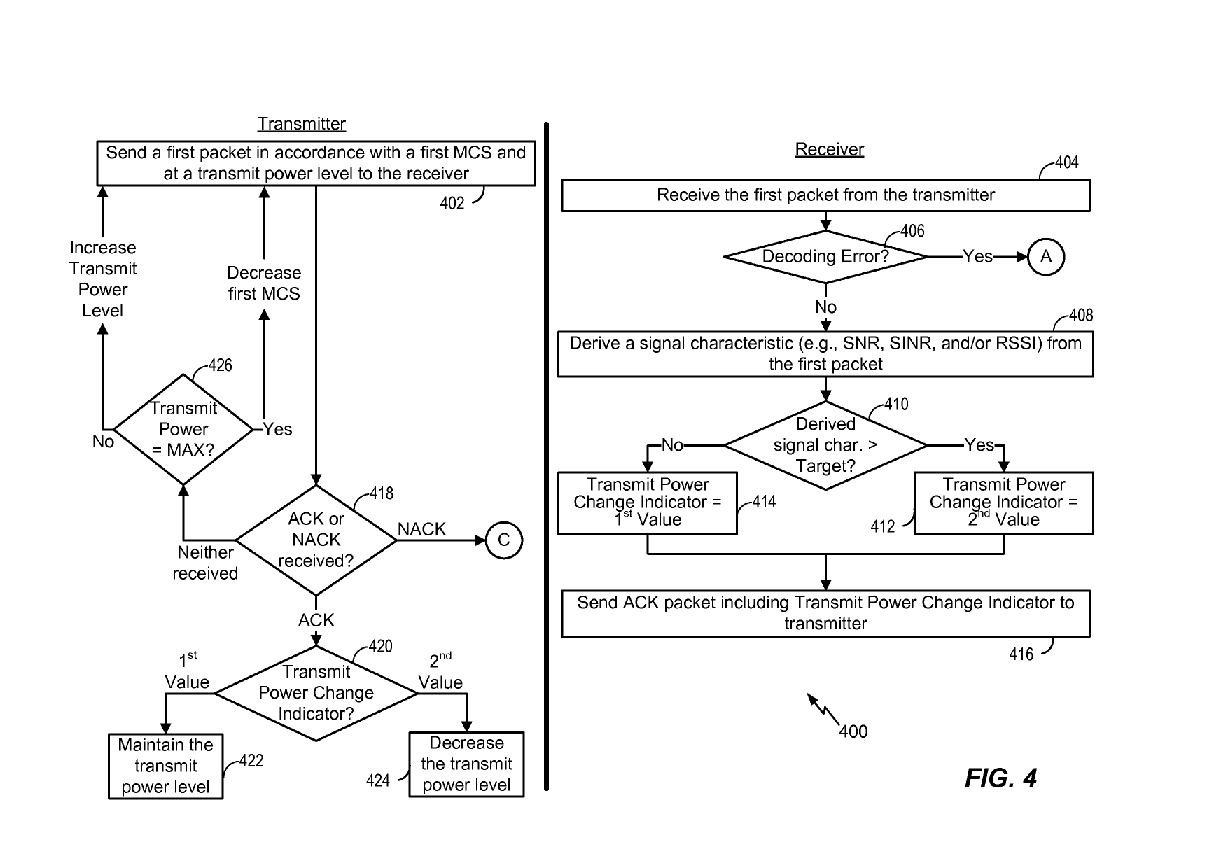

Referring to FIG. 5, a particular embodiment of a method of performing collision detection in conjunction with the method of FIG. 3 or the method of FIG. 4 is disclosed and generally designated 500. If it is determined that there is a decoding error at 306, flow proceeds to FIG. 5, where the method 500 includes determining whether the error is caused by a channel condition or by a collision, at 502. For example, the second wireless device 140 may determine the error by successfully decoding a PHY preamble of the first packet 132 transmitted by the first wireless device 110 but unsuccessfully decoding a remainder of the first packet 132, and may determine whether the decoding error was due to poor channel conditions or due to a collision.

The second wireless device 140 may determine whether the error was caused by a collision in a number of ways. For example, the second wireless device 140 may infer collision by determining whether the RSSI derived from the first packet 132 is within a particular range. The second wireless device 140 may also infer collision by determining whether the RSSI is greater than a previous RSSI by more than a threshold amount and whether the SNR derived from the first packet 132 is less than a previous SNR, where the previous RSSI and the previous SNR are each derived from a previous packet received from the first wireless device 110. The second wireless device 140 may infer collision by determining whether the RSSI exhibits a sudden increase or decrease. In addition, the second wireless device 140 may infer collision by determining whether the SNR can support the first MCS. It should be noted that the second wireless device 140 may infer collision based on any combination of the above methods.

The method 500 also includes sending a NACK packet to the transmitter based on the determination, at 504. For example, the second wireless device 140 may determine whether an error during decoding of the first packet 132 is caused by a channel condition or a collision, and may send the NACK packet 136 to the first wireless device 110 based on the determination. To illustrate, a portion of the NACK packet 136 may include a bit indicating whether the decoding error was caused by a channel condition or by a collision. For example, a bit of ‘0’ of the NACK packet 136 may indicate poor channel conditions and a bit of ‘1’ may indicate a collision, or vice versa.

Referring back to FIG. 3, if it is determined that there is no decoding error, at 306 (i.e., the second wireless device 140 successfully decodes the first packet 132), the method 300 includes estimating a second MCS based on a signal characteristic derived from the first packet, at 308. For example, the second wireless device 140 may receive (and decode) the first packet 132 and may estimate the second MCS based on a signal characteristic (e.g., SNR, SINR, and/or RSSI) derived from the first packet 132. To illustrate, the signal metrics module 148 of the second wireless device 140 may be configured to calculate SINR based on a PHY preamble of the first packet 132 or based on a data payload of the first packet 132. The calculated SINR may be mapped to a particular MCS or historical MCS (e.g., the second MCS) stored in the memory 150 of the second wireless device.

The method 300 also includes determining whether the second MCS is greater than the first MCS, at 310. If it is determined that the second MCS is greater than the first MCS, the method 300 includes setting the MCS change indicator to a second value, at 312, and sending an ACK packet including the MCS change indicator to the transmitter, at 316. If however, it is determined that the second MCS is not greater than the first MCS (i.e., the second MCS is less than or equal to the first MCS), the method 300 includes setting the MCS change indicator to a first value, at 314, and sending the ACK packet including the MCS change indicator to the transmitter, at 316. For example, when the second MCS is greater than the first MCS, the second wireless device 140 may set the MCS change indicator to the second value instructing the first wireless device 110 to increase the first MCS. When the second MCS is less than or equal to the first MCS, the second wireless device 140 may set the MCS change indicator to the first value instructing the first wireless device 110 to maintain the first MCS.

The method 300 includes determining whether the ACK packet or the NACK packet is received at the transmitter, at 318. If the NACK packet is received, the method proceeds to step C (i.e., FIG. 5). If the ACK packet is received, the method 300 includes determining the value of the MCS change indicator, at 320. For example, the first wireless device 110 may receive the NACK packet 136 or the ACK packet 134 from the second wireless device 140.

If the NACK packet is received at the transmitter, the method includes determining whether the NACK indicates the error is caused by a collision or by channel conditions, at 506. If the error is caused by a collision, the method includes maintaining the first MCS and the transmit power level, at 508. If the error is caused by channel conditions, the method includes decreasing the first MCS and/or increasing the transmit power level, at 510. For example, a bit of ‘0’ in the NACK packet 136 may indicate poor channel conditions and a bit of ‘1’ may indicate a collision, or vice versa. When the error is caused by the channel condition, the NACK packet 136 may instruct the first wireless device 110 (or the first wireless device 110 may elect) to decrease the first MCS, increase the transmit power level, or any combination thereof. When the error is caused by the collision, the NACK packet 136 may instruct the first wireless device 110 (or the first wireless device 110 may elect) to maintain the first MCS and the transmit power level. Alternately, the first wireless device 110 may update the MCS and/or the transmit power level even when the error was caused by a collision.

Referring to FIG. 3, if the ACK packet is received at the transmitter, at 318, the method 300 includes determining a value of the MCS change indicator, at 320. If the MCS change indicator includes a first value, the method 300 includes maintaining the first MCS, at 322. If the MCS change indicator includes a second value, the method 300 includes incrementing the first MCS, at 324. In a particular embodiment, the second value instructs the transmitter to reduce the transmit power when the transmit power is at a particular level (e.g., a maximum transmit power level). If neither the ACK packet nor the NACK packet is received at 318, the method also includes decreasing the MCS (if possible). For example, if the ACK packet 134 or the NACK packet 136 is not received at the first wireless device 110 within a predetermined time period, the first wireless device 110 may retransmit the first packet 132 in accordance with a decreased MCS (i.e., if the first MCS is not a lowest possible MCS). In a particular embodiment, if neither the ACK packet nor the NACK packet is received at 318, the method includes increasing the transmit power level. For example, the first wireless device 110 retransmits the first packet 132 in accordance with an increased transmit power level (when decreasing the first MCS is not feasible) as compared to the transmit power level used to transmit the first packet 132 for the first time.

Referring to FIG. 4, a flowchart of a particular embodiment of a method of performing power control is disclosed and generally designated 400. The method 400 may be performed by a transmitter in communication with a receiver. For example, the transmitter may be the first wireless device 110 of FIG. 1 and the receiver may be the second wireless device 140 of FIG. 1.

The method 400 includes sending a first packet in accordance with a first MCS and at a transmit power level to the receiver, at 402 and receiving the first packet from the transmitter, at 404. For example, the first wireless device 110 may transmit the first packet 132 to the second wireless device 140 in accordance with the first MCS and at a transmit power level.

The method 400 includes determining whether or not there is a decoding error, at 406. If it is determined that there is a decoding error, the method 400 proceeds to step A described with reference to FIG. 5. If however, there is no decoding error, the method 400 includes deriving a signal characteristic from the first packet, at 408. For example, the second wireless device 140 may receive the first packet 132 sent from the first wireless device 110 and may begin a decoding process. If the second wireless device 140 successfully decodes the first packet 132 (i.e., no decoding error), the second wireless device may derive a signal characteristic (e.g., SNR, SINR, and/or SINR) from the first packet 132.

If the second wireless device is unable to decode the first packet 132, the method 400 proceeds to FIG. 5, where the method includes determining whether the error is caused by a channel condition or by collision, at 502. The method 400 also includes sending a NACK packet to the transmitter based on the determination, at 504. For example, the second wireless device 140 may send the NACK packet 136 to the first wireless device 110 indicating whether the error was caused by the channel condition or by the collision.

Referring to FIG. 4, upon determining that there is no decoding error, the method 400 also includes comparing the derived signal characteristic from the first packet 132 to a target signal characteristic, at 410. For example, the second wireless device 140 may determine if the signal characteristic derived from the first packet 132 is greater than a target signal characteristic (e.g., “optimum” or “expected”) signal characteristic associated with the first MCS.

If it is determined that the derived signal characteristic is greater than the target signal characteristic, the method 400 includes setting a transmit power level change indicator to a second value, at 412, and sending an ACK packet including the transmit power level change indicator to the transmitter, at 416. If it is determined that the derived signal characteristic is not greater than the target signal characteristic (i.e., the derived signal characteristic is less than or equal to the target signal characteristic), the method 400 includes setting the transmit power level change indicator to a first value, at 414, and sending the ACK packet including the transmit power level change indicator to the transmitter, at 416.

For example, when the derived signal characteristic is greater than the target signal characteristic, the second wireless device 140 may set the transmit power level change indicator to the second value instructing the first wireless device 110 to decrease the transmit power level. When the derived signal characteristic is less than or equal to the target signal characteristic, the second wireless device 140 may set the transmit power level change indicator to the first value instructing the first wireless device 110 to maintain the transmit power level.

The method 400 further includes determining whether the ACK packet or the NACK packet is received at the transmitter, at 418. If the NACK packet is received, the method 400 proceeds to step C described with reference to FIG. 5. If however, the ACK packet is received, the method 400 includes determining the value of the transmit power level change indicator, at 420. For example, the first wireless device 110 may receive a response from the second wireless device in the form of the NACK packet 136 or the ACK packet 134.

Referring to FIG. 5, if the NACK packet is received at the transmitter, the method includes determining whether the NACK indicates the error is caused by a collision or by channel conditions, at 506. If the error is caused by collision, the method includes maintaining the first MCS and the transmit power level, at 508. If the error is caused by channel conditions, the method includes decreasing the first MCS and/or increasing the transmit power level, at 510. When the error is caused by the channel condition, the NACK packet 136 may instruct the first wireless device 110 (or the first wireless device 110 may elect) to decrease the first MCS, increase the transmit power level, or any combination thereof. When the error is caused by the collision, the NACK packet 136 may instruct the first wireless device 110 (or the first wireless device 110 may elect) to maintain the first MCS and the transmit power level. Alternately, the first wireless device 110 may update the MCS and/or the transmit power level even when the error was caused by a collision.

Referring to FIG. 4, if the ACK packet is received at the transmitter, the method includes determining a value of the transmit power level change indicator, at 420. If the transmit power level change indicator is the first value, the method 400 includes maintaining the transmit power level, at 422. If the transmit power level change indicator is the second value, the method 400 includes decreasing the transmit power level, at 424. If neither the ACK packet nor the NACK packet is received (i.e., no response to the first packet 132 sent by the transmitter), the method 400 also includes determining whether or not the transmit power level is at the maximum transmit power level, at 426. For example, if the ACK packet 134 or the NACK packet 136 is not received at the first wireless device (e.g., within a predetermined time period), the first wireless device may retransmit the first packet 132 at an increased power level when the transmit power level is less than the maximum transmit power level. Further, if neither the ACK packet 134 nor the NACK packet 136 is received at the first wireless device 110, the first wireless device 110 may retransmit the first packet 132 at a decreased MCS (i.e., decreased from the first MCS) when the transmit power level is equal to the maximum transmit power level.

Embodiments described herein may be used to produce a short ACK packet when there is no HT control field (e.g., used for fast link adaptation in IEEE 802.11n/ac networks) in the MAC header. Embodiments described herein may also be used with respect to a request to send (RTS)/clear to send (CTS) scenario. For example, a CTS message may include a MCS/power change indicator (as described with reference to the ACK packet 134 of FIG. 1), where the MCS/power change indicator instructs a transmitter to choose a higher or lower MCS/power than the MCS/power used to transmit a previous RTS message. Thus, embodiments described herein may be used to perform fast MCS control using one bit of a CTS message and/or fast power control using one bit (e.g., the same bit as for MCS control or a different bit) of the CTS message.

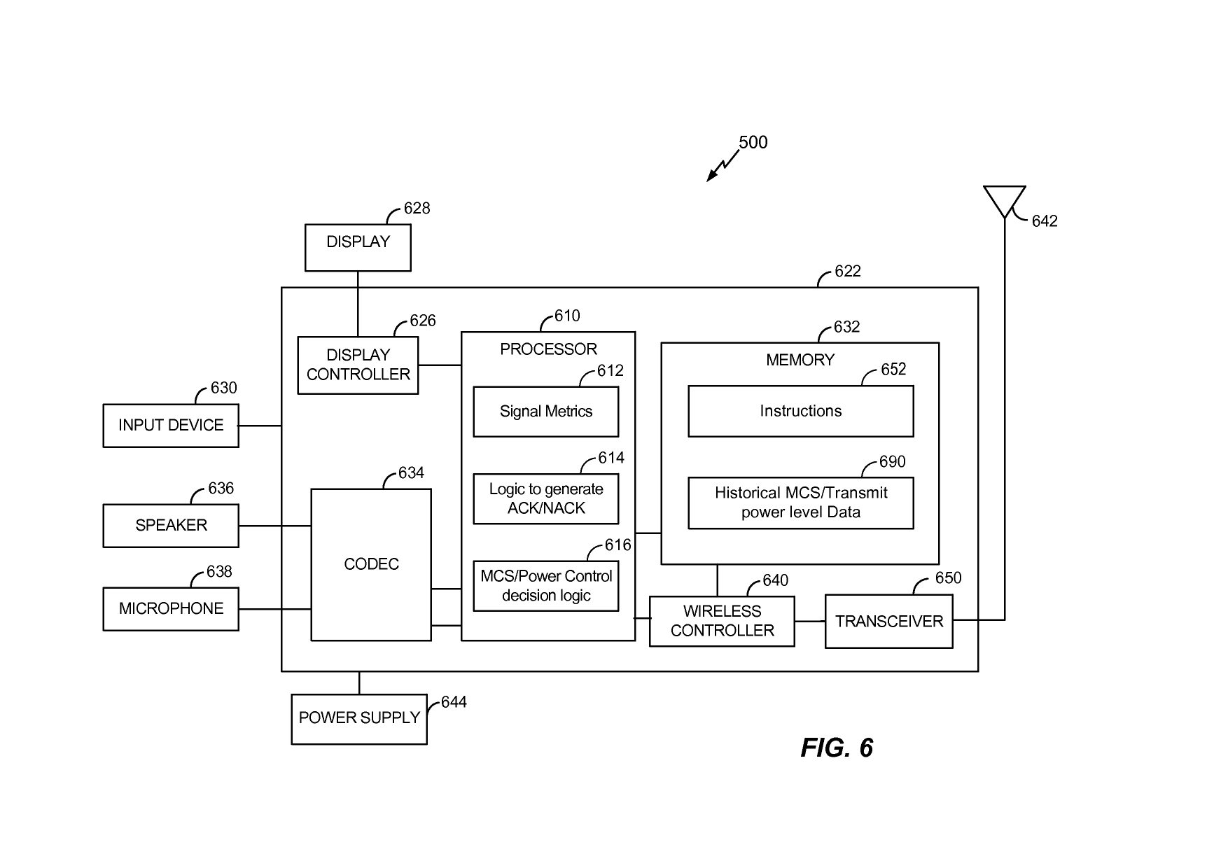

Referring to FIG. 6, a block diagram of a particular embodiment of a wireless device including a processor operable to perform rate control and power control in accordance with the described embodiments is disclosed and generally designated 600. The device 600 includes a processor, such as a processor 610, coupled to a memory 632. The processor 610 may include a signal metrics module 612, logic 614 to generate ACK/NACK packets, and MCS/Power Control decision logic 616.

The memory 632 may be a non-transitory computer readable storage medium that stores data (e.g., representative historical MCS/transmit power level data 690), instructions, or both. In a particular embodiment, the memory 632 may include instructions 652 that may be executable by the processor 610 to cause the processor 610 to perform one or more functions of the device 600. For example, the instructions 652 may include user applications, an operating system, or other executable instructions, or a combination thereof. The instructions 652 may be executable by the processor 610 to cause the processor 610 to perform at least a portion of the functionality described with respect to any of FIGS. 1-5. For example, the instructions 652 may include instructions that are executable by a computer (e.g., the processor 610) to cause the computer to perform the method 300 of FIG. 3, the method 400 of FIG. 4, and the method 500 of FIG. 5.

The device 600 may include a transceiver 650 for sending and receiving signals and/or data packets. For example, the device 600 may function as a transmitter when the device 600 transmits signals and/or packets and may function as a receiver when the device 600 receives signals and/or packets. In a particular embodiment, the signal metrics module 612 may be configured to determine signal characteristics (e.g., SNR, SINR, and RSSI) of a received signal. In response to determining the signal characteristics, the MCS/Power Control logic 616 may be configured to maintain/increment/decrement the MCS and/or the transmit power level associated with a data packet. In a particular embodiment, when the device 600 receives a data packet from a second device, the logic 614 may be configured to generate an ACK packet or a NACK packet in response to the data packet. The ACK packet and/or the NACK packet may instruct the second device to maintain/increment/decrement a MCS and/or a transmit power level.

FIG. 6 also shows a display controller 626 that may be coupled to the processor 610 and to a display 628. A coder/decoder (CODEC) 634 (e.g., an audio and/or voice CODEC) may be coupled to the processor 610. A speaker 636 and a microphone 638 may be coupled to the CODEC 634. FIG. 6 also indicates that a wireless controller 640 may be coupled to the processor 610 and to the transceiver 650 that is coupled to a wireless antenna 642. In a particular embodiment, the processor 610, the display controller 626, the memory 632, the CODEC 634, the wireless controller 640, and the transceiver 650 are included in a system-in-package or system-on-chip device 622.

In a particular embodiment, an input device 630 and a power supply 644 are coupled to the system-on-chip device 622. Moreover, in a particular embodiment, as illustrated in FIG. 6, the display 628, the input device 630, the speaker 636, the microphone 638, the wireless antenna 642, and the power supply 644 are external to the system-on-chip device 622. However, each of the display 628, the input device 630, the speaker 636, the microphone 638, the wireless antenna 642, and the power supply 644 can be coupled to a component of the system-on-chip device 622, such as an interface or a controller.

It should be noted that although FIG. 6 depicts a wireless communications device, the processor 610 and the memory 632 may be integrated into other devices, such as a multimedia player, an entertainment unit, a navigation device, a personal digital assistant (PDA), a fixed location data unit, or a computer (e.g., a tablet computer, a laptop computer, a desktop computer, etc), a media device, a router or gateway device, or another device configured to wirelessly communicate data.

In conjunction with the described embodiments, an apparatus may include means for transmitting a first packet to a wireless device, where data within the first packet is encoded and a signal representing the first packet is modulated in accordance with a modulation and coding scheme (MCS) and where the signal is transmitted at a transmit power level. For example, the means for transmitting the first packet may include the transmitter 112 of FIG. 1, the first wireless device 110 of FIG. 1, the transmitter 142 of FIG. 1, the second wireless device 140 of FIG. 1, the transceiver 650 of FIG. 6, the device 600 of FIG. 6, one or more other devices configured to transmit the first packet, or any combination thereof.

The apparatus may also include means for receiving an acknowledgement packet from the wireless device in response to transmitting the first packet. For example, the means for receiving the acknowledgement packet may include the receiver 114 of FIG. 1, the first wireless device 110 of FIG. 1, the receiver 144 of FIG. 1, the second wireless device 140 of FIG. 1, the transceiver 650 of FIG. 6, the device 600 of FIG. 6, one or more other devices configured to receive the acknowledgement packet, or any combination thereof.

The apparatus may further include means for determining whether to change the MCS and the transmit power level in response to receipt of the acknowledgement packet. The means for determining is configured to maintain the MCS when a MCS change indicator of the acknowledgement packet has a first value and to increment the MCS when the MCS change indicator of the acknowledgement packet has a second value. For example, the means for determining may include the processor 116 of FIG. 1, the processor 146 of FIG. 1, the MCS/Power Control decision logic 616 of FIG. 6, the processor 610 of FIG. 6, one or more other devices configured to determine whether to change the MCS and the transmit power level, or any combination thereof. In a particular embodiment, the means for transmitting retransmits the packet in accordance with a second MCS that is less than the MCS in response to the acknowledgment packet not being received within a time period.

In a particular embodiment, the apparatus also includes means for receiving an acknowledgement packet that includes a transmit power level change indicator from a second wireless device in response to transmitting the packet. For example, the means for receiving may include the receiver 114 of FIG. 1, the first wireless device 110 of FIG. 1, the receiver 144 of FIG. 1, the second wireless device 140 of FIG. 1, the transceiver 650 of FIG. 6, the device 600 of FIG. 6, one or more other devices configured to receive the acknowledgement packet, or any combination thereof.

In another particular embodiment, the apparatus further includes means for determining whether to change a transmit power level. The means for determining is configured to maintain the transmit power level when the transmit power level change indicator has a first value and to decrease the transmit power level when the transmit power level change indicator has a second value. For example, the means for determining may include the processor 116 of FIG. 1, the processor 146 of FIG. 1, the MCS/Power Control decision logic 616 of FIG. 6, the processor 610 of FIG. 6, one or more other devices configured to determine whether to change the MCS and the transmit power level, or any combination thereof.

A second apparatus may include means for receiving a packet transmitted from a wireless device, the packet indicating a first modulation and coding scheme (MCS) and transmitted at a transmit power level. For example, the means for receiving the packet may include the receiver 114 of FIG. 1, the first wireless device 110 of FIG. 1, the receiver 144 of FIG. 1, the second wireless device 140 of FIG. 1, the transceiver 650 of FIG. 6, the device 600 of FIG. 6, one or more other devices configured to receive the packet, or any combination thereof.

The second apparatus may also include means for estimating a second MCS based on a signal characteristic derived from the packet. For example, the means for estimating may include the signal metrics module 118 of FIG. 1, the processor 116 of FIG. 1, the signal metrics module 148 of FIG. 1, the processor 146 of FIG. 1, the signal metrics module 612 of FIG. 6, the processor 610 of FIG. 6, one or more other devices configured to estimate a MCS based on a signal characteristic, or any combination thereof.

The second apparatus may further include means for transmitting an acknowledgement packet that includes a MCS change indicator to the wireless device. The MCS change indicator instructs the wireless device to increment the first MCS when the second MCS is greater than the first MCS and the first MCS is less than a particular level. The MCS change indicator instructs the wireless device to reduce the transmit power level when the second MCS is greater than the first MCS and the first MCS is at the particular level. The MCS change indicator instructs the wireless device to maintain the first MCS when the second MCS is less than or equal to the first MCS. For example, the means for transmitting may include the transmitter 112 of FIG. 1, the first wireless device 110 of FIG. 1, the transmitter 142 of FIG. 1, the second wireless device 140 of FIG. 1, the transceiver 650 of FIG. 6, the device 600 of FIG. 6, one or more other devices configured to send the acknowledgement packet, or any combination thereof.

In a particular embodiment, the second apparatus further includes means for comparing a signal characteristic derived from the packet to a target signal characteristic. For example, the means for comparing may include the signal metrics module 118 of FIG. 1, the processor 116 of FIG. 1, the signal metrics module 148 of FIG. 1, the processor 146 of FIG. 1, the signal metrics module 612 of FIG. 6, the processor 610 of FIG. 6, one or more other devices configured to compare the signal characteristics to the target signal characteristic, or any combination thereof.

In a particular embodiment, the second apparatus further includes means for decoding the packet. For example, the means for decoding may include the processor 146 of FIG. 1, the signal metrics module 148 of FIG. 1, the processor 610 of FIG. 6, the CODEC 634 of FIG. 6, one or more other devices configured to decode a packet, or any combination thereof.

In another particular embodiment, the second apparatus further includes means for determining whether an error is caused by a channel condition or a collision in response to the error detected by the means for decoding. For example, the means for determining may include the signal metrics module 118 of FIG. 1, the processor 116 of FIG. 1, the signal metrics module 148 of FIG. 1, the processor 146 of FIG. 1, the signal metrics module 612 of FIG. 6, the processor 610 of FIG. 6, one or more other devices configured to determine whether an error is caused by a channel condition or a collision, or any combination thereof. The second apparatus may further include means for transmitting a negative acknowledgement packet to the wireless device based on the determination. The negative acknowledgement packet instructs the wireless device to decrease the MCS, increase the transmit power level, or any combination thereof when the error is caused by the channel condition. The negative acknowledgement packet instructs the wireless device to maintain the MCS and the transmit power level when the error is caused by the collision. For example, the means for transmitting may include the transmitter 112 of FIG. 1, the first wireless device 110 of FIG. 1, the transmitter 142 of FIG. 1, the second wireless device 140 of FIG. 1, the transceiver 650 of FIG. 6, the device 600 of FIG. 6, one or more other devices configured to transmit a negative acknowledgement packet, or any combination thereof.

One or more of the disclosed embodiments may be implemented in a system or an apparatus that includes a communications device, a fixed location data unit, a mobile location data unit, a mobile phone, a cellular phone, a computer, a tablet, a portable computer, or a desktop computer. Additionally, the system or the apparatus may include a set top box, an entertainment unit, a navigation device, a personal digital assistant (PDA), a monitor, a computer monitor, a television, a tuner, a radio, a satellite radio, a music player, a digital music player, a portable music player, a video player, a digital video player, a digital video disc (DVD) player, a portable digital video player, any other device that stores or retrieves data or computer instructions, or a combination thereof. As another illustrative, non-limiting example, the system or the apparatus may include remote units, such as mobile phones, hand-held personal communication systems (PCS) units, portable data units such as personal data assistants, global positioning system (GPS) enabled devices, navigation devices, fixed location data units such as meter reading equipment, or any other device that stores or retrieves data or computer instructions, or any combination thereof. Although one or more of FIGS. 1-6 illustrate systems, apparatuses, and/or methods according to the teachings of the disclosure, the disclosure is not limited to these illustrated systems, apparatuses, and/or methods. Embodiments of the disclosure may be suitably employed in any device that includes memory, a processor, and circuitry.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed or that the first element must precede the second element in some manner. Also, unless stated otherwise a set of elements may comprise one or more elements.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

Various illustrative components, blocks, configurations, modules, circuits, and steps have been described above generally in terms of their functionality. Whether such functionality is implemented as hardware or processor executable instructions depends upon the particular application and design constraints imposed on the overall system. Additionally, the various operations of methods described above may be performed by any suitable means capable of performing the operations, such as various hardware and/or software component(s), circuits, and/or module(s). Generally, any operation illustrated in the FIGS. 1-6 may be performed by corresponding functional means capable of performing the operations. Skilled artisans may implement the described functionality in varying ways for each particular application, but such implementation decisions should not be interpreted as causing a departure from the scope of the present disclosure.

Those of skill in the art would further appreciate that the various illustrative logical blocks, configurations, modules, circuits, and algorithm steps described in connection with the present disclosure may be implemented or performed with a general purpose processor, a digital signal processor (DSP), an application specific integrated circuit (ASIC), a field programmable gate array (FPGA), a programmable logic device (PLD), discrete gate or transistor logic, discrete hardware components (e.g., electronic hardware), computer software executed by a processor, or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored as one or more instructions or code on a computer-readable medium. Computer-readable media includes computer-readable storage media and communication media including any medium that facilitates transfer of computer program data from one place to another. A storage media may be any available media that can be accessed by a computer. By way of example, and not limitation, such computer-readable storage media can include random access memory (RAM), read-only memory (ROM), programmable read-only memory (PROM), erasable PROM (EPROM), electrically erasable PROM (EEPROM), register(s), hard disk, a removable disk, a compact disc read-only memory (CD-ROM), other optical disk storage, magnetic disk storage, magnetic storage devices, or any other medium that can be used to store program code in the form of instructions or data and that can be accessed by a computer. In the alternative, the computer-readable media (e.g., a storage medium) may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

Also, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), and floppy disk where disks usually reproduce data magnetically, while discs reproduce data optically with lasers. Thus, in some aspects computer readable medium may include a non-transitory computer readable storage medium (e.g., tangible media). In addition, in some aspects computer readable medium may include a transitory computer readable medium (e.g., a signal). Combinations of the above should also be included within the scope of computer-readable media.

The methods disclosed herein include one or more steps or actions. The method steps and/or actions may be interchanged with one another without departing from the scope of the claims. In other words, unless a specific order of steps or actions is specified, the order and/or use of specific steps and/or actions may be modified without departing from the scope of the disclosure.

Certain aspects may include a computer program product for performing the operations presented herein. For example, a computer program product may include a computer-readable storage medium having instructions stored (and/or encoded) thereon, the instructions being executable by one or more processors to perform the operations described herein. The computer program product may include packaging material.

Further, it should be appreciated that modules and/or other appropriate means for performing the methods and techniques described herein can be downloaded and/or otherwise obtained by a user terminal and/or base station as applicable. Alternatively, various methods described herein can be provided via storage means (e.g., RAM, ROM, a physical storage medium such as a compact disc (CD)). Moreover, any other suitable technique for providing the methods and techniques described herein can be utilized. It is to be understood that the scope of the disclosure is not limited to the precise configuration and components illustrated above.

The previous description of the disclosed embodiments is provided to enable a person skilled in the art to make or use the disclosed embodiments. While the foregoing is directed to aspects of the present disclosure, other aspects of the disclosure may be devised without departing from the basic scope thereof, and the scope is determined by the claims that follow. Various modifications, changes and variations may be made in the arrangement, operation, and details of the embodiments described herein without departing from the scope of the disclosure or the claims. Thus, the present disclosure is not intended to be limited to the embodiments herein but is to be accorded the widest scope possible consistent with the principles and novel features as defined by the following claims and equivalents thereof.

What is claimed is:

1. A method comprising:
transmitting a packet from a first wireless device to a second wireless device, wherein data within the packet is encoded and a signal representing the packet is modulated in accordance with a modulation and coding scheme (MCS);
responsive to receiving an acknowledgement packet that includes a MCS change indicator from the second wireless device via a wireless local area network (WLAN) in response to transmitting the packet:
when the MCS change indicator has a first value, maintaining the MCS; and
when the MCS change indicator has a second value, incrementing the MCS.

2. The method of claim 1, wherein the packet is transmitted at a first transmit power level, the method further comprising, when the acknowledgement packet is not received in response to the packet within a time period, retransmitting the packet in accordance with a second transmit power level that is greater than the first transmit power level.

3. The method of claim 1, wherein the packet is transmitted from the first wireless device in accordance with a lowest MCS upon a wakeup of the first wireless device.

4. The method of claim 3, wherein the lowest MCS comprises a lowest available MCS of the first wireless device, a lowest historically used MCS with respect to the second wireless device, a lowest historically used MCS with respect to a particular wireless channel in use by the first wireless device, or any combination thereof.

5. The method of claim 3, wherein the lowest MCS is stored at the first wireless device.

6. The method of claim 1, wherein the WLAN is compliant with an Institute of Electrical and Electronics Engineers (IEEE) 802.11 protocol.

7. The method of claim 1, wherein the MCS change indicator includes fewer than seven bits.

8. The method of claim 7, wherein the MCS change indicator is a single bit.

9. The method of claim 7, wherein the MCS change indicator is a pair of bits.

10. The method of claim 1, wherein the MCS change indicator is included in a physical layer (PHY) preamble of the acknowledgement packet, a signal (SIG) field of the PHY preamble, a media access control (MAC) header of the acknowledgement packet, a high throughput (HT) control field of the acknowledgement packet, or a combination thereof.

11. The method of claim 1, wherein the acknowledgement packet is a block acknowledgement.

12. The method of claim 1, further comprising decrementing the MCS when the MCS change indicator included in the acknowledgement packet has a third value.

13. The method of claim 1, wherein the packet is included in a request to send (RTS) message.

14. The method of claim 1, wherein the acknowledgement packet is included in a clear to send (CTS) message.

15. The method of claim 1, wherein when the MCS change indicator has the second value and when the MCS is at a particular level, decreasing a transmission power for use in a subsequent transmission to the second wireless device.

16. The method of claim 1, further comprising in response to the acknowledgement packet not being received within a time period, retransmitting the packet in accordance with a second MCS that is less than the MCS.

17. A method comprising:
receiving a packet transmitted by a first wireless device at a second wireless device, the packet indicating a first modulation and coding scheme (MCS);
estimating a second MCS at the second wireless device based on a signal characteristic derived from the packet;
when the second MCS is greater than the first MCS, transmitting a first acknowledgment packet from the second wireless device to the first wireless device with a MCS change indicator, wherein the MCS change indicator instructs the first wireless device to increment the first MCS when the first MCS is less than a particular level and to reduce a transmit power level when the first MCS is at the particular level; and
when the second MCS is less than or equal to the first MCS, transmitting a second acknowledgement packet to the first wireless device with an indicator that instructs the first wireless device to maintain the first MCS.

18. The method of claim 17, wherein the packet is transmitted from the first wireless device in accordance with a lowest MCS upon a wakeup of the first wireless device.

19. The method of claim 18, wherein the lowest MCS comprises a lowest available MCS of the first wireless device, a lowest historically used MCS with respect to the second wireless device, a lowest historically used MCS with respect to a particular wireless channel in use by the first wireless device, or any combination thereof.

20. The method of claim 18, wherein the lowest MCS is stored at the first wireless device.

21. The method of claim 17, wherein the packet and the acknowledgement packet are transmitted via an Institute of Electrical and Electronics Engineers (IEEE) 802.11ah compliant protocol.

22. The method of claim 17, wherein the MCS change indicator includes fewer than seven bits.

23. The method of claim 22, wherein the MCS change indicator is a single bit.

24. The method of claim 22, wherein the MCS change indicator is a pair of bits.

25. The method of claim 17, wherein the MCS change indicator is included in a physical layer (PHY) preamble of the acknowledgement packet, a signal (SIG) field of the PHY preamble, a media access control (MAC) header of the acknowledgement packet, a high throughput (HT) control field of the acknowledgement packet, or a combination thereof.

26. The method of claim 17, wherein the acknowledgement packet is a block acknowledgement.

27. The method of claim 17, further comprising decrementing the MCS when the MCS change indicator included in the acknowledgement packet has a third value.

28. The method of claim 17, wherein the packet is included in a request to send (RTS) message.

29. The method of claim 17, wherein the acknowledgement packet is included in a clear to send (CTS) message.

30. A method comprising:
transmitting a packet from a first wireless device to a second wireless device at a transmit power level; and
when an acknowledgement packet that includes a transmit power level change indicator is received from the second wireless device in response to the packet:
when the transmit power level change indicator has a first value, maintaining the transmit power level; and
when the transmit power level change indicator has a second value, decreasing the transmit power level.

31. The method of claim 30, further comprising, when an acknowledgement packet is not received in response to the packet within an acknowledgement response time period:
when the transmit power level is less than a particular transmit power level, retransmitting the packet at an increased power level; and
when the transmit power is equal to the particular transmit power level, retransmitting the packet in accordance with a decreased modulation and coding scheme (MCS).

32. A method comprising:
receiving a packet transmitted by a first wireless device at a second wireless device, the packet indicating a selected modulation and coding scheme (MCS) and transmitted at a transmit power level;
comparing a signal characteristic derived from the packet to a target signal characteristic associated with the selected MCS;
when the derived signal characteristic is greater than the target signal characteristic, transmitting a first acknowledgement packet from the second wireless device to the first wireless device, wherein the first acknowledgement packet includes a transmit power level change indicator that instructs the first wireless device to decrease the transmit power level; and
when the derived signal characteristic is less than or equal to the target signal characteristic, transmitting a second acknowledgement packet to the first wireless device with an indicator that instructs the first wireless device to maintain the transmit power level.

33. A method comprising:
receiving a packet transmitted by a first wireless device at a second wireless device, the packet indicating a modulation and coding scheme (MCS) and transmitted at a transmit power level; and
in response to an error detected during decoding of the packet, determining whether the error is caused by a channel condition or a collision; and
transmitting a negative acknowledgement packet to the first wireless device based on the determination,
wherein when the error is caused by the channel condition, the negative acknowledgement packet instructs the first wireless device to decrease the MCS, increase the transmit power level, or any combination thereof, and
wherein when the error is caused by the collision, the negative acknowledgement packet instructs the first wireless device to maintain the MCS and the transmit power level.

34. The method of claim 33, wherein determining whether the error is caused by the channel condition or the collision comprises:
determining whether a received signal strength indication (RSSI) derived from the packet is within a particular range,
determining whether the RSSI is greater than a previous RSSI by more than a threshold amount and whether a signal to noise ratio (SNR) derived from the packet is less than a previous SNR, the previous RSSI and the previous SNR each derived from a previous packet received from the first wireless device,
determining whether the RSSI exhibits a sudden increase or decrease,
determining whether the SNR can support the MCS,
or any combination thereof.

35. An apparatus comprising:
a processor; and
a memory storing instructions executable by the processor to:
initiate transmission of a packet to a wireless device, wherein data within the packet is encoded and a signal representing the packet is modulated in accordance with a modulation and coding scheme (MCS) and wherein the signal is transmitted at a transmit power level; and
responsive to receipt of an acknowledgement packet from the wireless device via a wireless local area network (WLAN) in response to transmitting the packet:
when a MCS change indicator of the acknowledgement packet has a first value, maintain the MCS;
when the MCS change indicator of the acknowledgement packet has a second value, increment the MCS.

36. The apparatus of claim 35, wherein the MCS change indicator is a single bit.

37. The apparatus of claim 35, wherein the acknowledgement packet further includes a transmit power level change indicator, and wherein the transmit power level change indicator is a single bit.

38. The apparatus of claim 37, wherein the MCS change indicator and the transmit power level change indicator share at least one common bit.

39. The apparatus of claim 35, wherein the instructions are further executable by the processor to, when an acknowledgement packet is not received in response to the packet within a time period, retransmit the packet in accordance with a decreased MCS, at an increased power level, or any combination thereof.

40. The apparatus of claim 35, wherein the WLAN is compliant with an Institute of Electrical and Electronics Engineers (IEEE) 802.11 protocol.

41. The apparatus of claim 35, wherein the instructions are further executable by the processor to, in response to the acknowledgement packet not being received within a time period, re-initiate transmission of the packet in accordance with a second MCS that is less than the MCS

42. An apparatus comprising:
a processor; and
a memory storing instructions executable by the processor to:
detect receipt of a packet transmitted from a wireless device, the packet indicating a first modulation and coding scheme (MCS) and transmitted at a transmit power level;
estimate a second MCS based on a signal characteristic derived from the packet; and
initiate transmission of an acknowledgement packet that includes a MCS change indicator to the wireless device, wherein:
when the second MCS is greater than the first MCS and the first MCS is less than a particular level, the MCS change indicator instructs the wireless device to increment the first MCS;
when the second MCS is greater than the first MCS and the first MCS is at the particular level, the MCS change indicator instructs the wireless device to reduce the transmit power level; and
when the second MCS is less than or equal to the first MCS, the MCS change indicator instructs the wireless device to maintain the first MCS.

43. An apparatus comprising:
a processor; and
a memory storing instructions executable by the processor to:
initiate transmission of a packet from a first wireless device to a second wireless device at a transmit power level; and
when an acknowledgement packet that includes a transmit power level change indicator is received from the second wireless device in response to transmitting the packet:
when the transmit power level change indicator has a first value, maintain the transmit power level; and
when the transmit power level change indicator has a second value, decrease the transmit power level.

44. The apparatus of claim 43, wherein when an acknowledgement packet is not received in response to the packet within an acknowledgement response time period:
when the transmit power level is less than a particular transmit power level, retransmitting the packet at an increased power level; and
when the transmit power is equal to the particular transmit power level, retransmitting the packet in accordance with a decreased modulation and coding scheme (MCS).

45. An apparatus comprising:
a processor; and
a memory storing instructions executable by the processor to:
detect receipt of a packet transmitted from a wireless device, the packet indicating a selected modulation and coding scheme (MCS) and transmitted at a transmit power level;
compare a signal characteristic derived from the packet to a target signal characteristic; and
initiate transmission of an acknowledgement packet to the wireless device, wherein:
when the derived signal characteristic is greater than the target signal characteristic, the acknowledgement packet includes a transmit power level change indicator that instructs the wireless device to decrease the transmit power level, and
when the derived signal characteristic is less than or equal to the target signal characteristic, the acknowledgement packet includes an indicator that instructs the wireless device to maintain the transmit power level.

46. An apparatus comprising:
a processor; and
a memory storing instructions executable by the processor to:
detect receipt of a packet transmitted from a wireless device, the packet indicating a modulation and coding scheme (MCS) and transmitted at a transmit power level;
in response to an error detected during decoding of the packet, determine whether the error is caused by a channel condition or a collision; and
initiate transmission of a negative acknowledgement packet to the wireless device based on the determination, wherein:
when the error is caused by the channel condition, the negative acknowledgement packet instructs the wireless device to decrease the MCS, increase the transmit power level, or any combination thereof, and
when the error is caused by the collision, the negative acknowledgment packet instructs the wireless device to maintain the MCS and the transmit power level.

47. The apparatus of claim 46, wherein the instructions executable by the processor to determine whether the error is caused by the channel condition or the collision includes instructions executable by the processor to:
determine whether a received signal strength indication (RSSI) derived from the packet is within a particular range,
determine whether the RSSI is greater than a previous RSSI by more than a threshold amount and whether a signal to noise ratio (SNR) derived from the packet is less than a previous SNR, the previous RSSI, and the previous SNR each derived from a previous packet received from the wireless device,
determine whether the RSSI exhibits a sudden increase or decrease,
determine whether the SNR can support the MCS,
or any combination thereof.

48. An apparatus comprising:
means for transmitting a packet to a wireless device, wherein data within the packet is encoded and a signal representing the packet is modulated in accordance with a modulation and coding scheme (MCS) and wherein the signal is transmitted at a transmit power level;
means for receiving an acknowledgement packet from the wireless device via a wireless local area network (WLAN) in response to transmitting the packet; and
means for determining whether to change the MCS in response to receipt of the acknowledgement packet, wherein the means for determining is configured to:
when a MCS change indicator of the acknowledgement packet has a first value, maintain the MCS; and
when the MCS change indicator of the acknowledgement packet has a second value, increment the MCS.

49. An apparatus comprising:
means for transmitting a packet from a first wireless device to a second wireless device at a transmit power level;
means for receiving an acknowledgement packet that includes a transmit power level change indicator from the second wireless device in response to transmitting the packet; and
means for determining whether to change the transmit power level, wherein the means for determining is configured to:
when the transmit power level change indicator has a first value, maintain the transmit power level; and
when the transmit power level change indicator has a second value, decrease the transmit power level.

50. An apparatus comprising:
means for receiving a packet transmitted from a wireless device, the packet indicating a first modulation and coding scheme (MCS) and transmitted at a transmit power level;
means for estimating a second MCS based on a signal characteristic derived from the packet; and
means for transmitting an acknowledgement packet that includes a MCS change indicator to the wireless device, wherein:
when the second MCS is greater than the first MCS and the first MCS is less than a particular level, the MCS change indicator instructs the wireless device to increment the first MCS;
when the second MCS is greater than the first MCS and the first MCS is at the particular level, the MCS change indicator instructs the wireless device to reduce the transmit power level; and
when the second MCS is less than or equal to the first MCS, the MCS change indicator instructs the wireless device to maintain the first MCS.

51. An apparatus comprising:
means for receiving a packet transmitted from a wireless device, the packet indicating a selected modulation and coding scheme (MCS) and transmitted at a transmit power level;
means for comparing a signal characteristic derived from the packet to a target signal characteristic; and
means for transmitting an acknowledgement packet to the wireless device, wherein:
when the derived signal characteristic is greater than the target signal characteristic, the acknowledgement packet includes a transmit power level change indicator that instructs the wireless device to decrease the transmit power level, and
when the derived signal characteristic is less than or equal to the target signal characteristic, the acknowledgement packet includes an indicator that instructs the wireless device to maintain the transmit power level.

52. An apparatus comprising:
means for receiving a packet transmitted from a wireless device, the packet indicating a modulation and coding scheme (MCS) and transmitted at a transmit power level;
means for determining whether an error in the packet is caused by a channel condition or a collision; and
means for transmitting a negative acknowledgement packet to the wireless device based on the determination, wherein:
when the error is caused by the channel condition, the negative acknowledgement packet instructs the wireless device to decrease the MCS, increase the transmit power level, or any combination thereof, and
when the error is caused by the collision, the negative acknowledgment packet instructs the wireless device to maintain the MCS and the transmit power level.

53. A computer-readable storage medium including instructions that, when executed by a processor, cause the processor to:
initiate transmission of a packet to a wireless device, wherein data within the packet is encoded and a signal representing the packet is modulated in accordance with a modulation and coding scheme (MCS) and wherein the signal is transmitted at a transmit power level;
responsive to receipt of an acknowledgement packet from the wireless device via a wireless local area network (WLAN) in response to transmitting the packet:
when a MCS change indicator of the acknowledgement packet has a first value, maintain the MCS; and
when the MCS change indicator of the acknowledgement packet has a second value, increment the MCS.

54. A computer-readable storage medium including instructions that, when executed by a processor, cause the processor to:
detect receipt of a packet transmitted from a wireless device, the packet indicating a first modulation and coding scheme (MCS) and transmitted at a transmit power level;
estimate a second MCS based on a signal characteristic derived from the packet; and
initiate transmission of an acknowledgement packet that includes a MCS change indicator to the wireless device, wherein:
when the second MCS is greater than the first MCS and the first MCS is less than a particular level, the MCS change indicator instructs the wireless device to increment the first MCS,
when the second MCS is greater than the first MCS and the first MCS is at the particular level, the MCS change indicator instructs the wireless device to reduce a transmit power level, and
when the second MCS is less than or equal to the first MCS, the MCS change indicator instructs the wireless device to maintain the first MCS.

55. A computer-readable storage medium including instructions that, when executed by a processor, cause the processor to:
initiate transmission of a packet from a first wireless device to a second wireless device at a transmit power level; and
when an acknowledgement packet that includes a transmit power level change indicator is received from the second wireless device in response to transmission of the packet:
when the transmit power level change indicator has a first value, maintain the transmit power level; and
when the transmit power level change indicator has a second value, decrease the transmit power level.

56. A computer-readable storage medium including instructions that, when executed by a processor, cause the processor to:
detect receipt of a packet transmitted from a wireless device, the packet indicating a selected modulation and coding scheme (MCS) and transmitted at a transmit power level;
compare a signal characteristic derived from the packet to a target signal characteristic; and
initiate transmission of an acknowledgement packet to the wireless device, wherein:
when the derived signal characteristic is greater than the target signal characteristic, the acknowledgement packet includes a transmit power level change indicator that instructs the wireless device to decrease the transmit power level, and
when the derived signal characteristic is less than or equal to the target signal characteristic, the acknowledgement packet includes an indicator that instructs the wireless device to maintain the transmit power level.

57. A computer-readable storage medium including instructions that, when executed by a processor, cause the processor to:
detect receipt of a packet transmitted from a wireless device, the packet indicating a modulation and coding scheme (MCS) and transmitted at a transmit power level;
in response to an error detected during decoding of the packet, determine whether the error is caused by a channel condition or a collision; and
initiate sending of a negative acknowledgement packet to the wireless device based on the determination, wherein:
when the error is caused by the channel condition, the negative acknowledgement packet instructs the wireless device to decrease the MCS, increase the transmit power level, or any combination thereof, and
when the error is caused by the collision, the negative acknowledgment packet instructs the wireless device to maintain the MCS and the transmit power level.
